(19) United States
(12) Patent Application Publication
(10) Pub. No.: US 2018/0344105 A1
(43) Pub. Date: Dec. 6, 2018

(54) Urinal Holder

(71) Applicant: Scott Jackson, Troy, MI (US)

(72) Inventor: Scott Jackson, Troy, MI (US)

(21) Appl. No.: 15/610,621

(22) Filed: Jun. 1, 2017

(51) Int. Cl. A47K 11/12; A61G 9/00

(52) U.S. Cl. CPC A47K 11/12; A61G 9/006

(57) ABSTRACT

A device is described herein for holding a urinal. The urinal holder includes a base and at least one side wall that together at least partially define a cavity for holding the urinal in a stationary position. The at least one side wall is coupled to the base at a location spaced apart from the perimeter of the base. An extension for hanging the urinal holder from a structure may be coupled to the at least one side wall. The extension may be integrally formed with the at least one side wall and may include a straight portion or a curved portion.

### BACKGROUND

The present invention relates to a holder for a urinal. In particular, the invention relates to a urinal holder for use with portable urinals, such as, but not limited to, those used for bedside patient care. Such urinals may be used in hospitals, nursing homes, hospice care centers, assisted living facilities, or personal residences, for example.

### BRIEF SUMMARY

A urinal holder comprises a base and at least one side wall coupled to the base at a location spaced apart from the perimeter of the base. A cavity for holding a urinal is at least partially defined by the base and the at least one side wall. The base has a first surface and a center on the first surface, wherein the center is one point on a line forming the central longitudinal axis of the cavity. The central longitudinal axis of the cavity may be orthogonal to a plane that is coplanar with the first surface or may form an angle with the first surface of less than 90 degrees. The urinal holder may include an extension for hanging the urinal holder from a structure, such as a bed rail. The extension may be formed integrally with the at least one side wall or formed separately and coupled thereto, and may include a straight portion or a curved portion.

A urinal holder comprises a base and a first, second, third, and fourth side wall coupled to the base at a location spaced apart from the perimeter of the base. A cavity for holding a urinal is at least partially defined by the base and the first side wall. The cavity may be also partially defined by each of the second, third, and fourth side walls. An extension for hanging the urinal holder from a structure may be formed integrally with one of the first, second, third, or fourth side walls or may be formed separately and coupled to one of the first, second, third, or fourth side walls. The extension may include a straight portion or a curved portion.

A urinal holder comprises a base with a first, second, third, and fourth edge and a first, second, third, and fourth side wall coupled to the base. The first, second, third, and fourth side walls are coupled to the base at a location spaced apart from the first, second, third, and fourth base edges, respectively. A cavity for holding a urinal is at least partially defined by the base and the first side wall. The cavity may be also partially defined by each of the second, third, and fourth side walls. An extension for hanging the urinal holder from a structure may be formed integrally with one of the first, second, third, or fourth side walls or may be formed separately and coupled to one of the first, second, third, or fourth side walls. The extension may include a straight portion or a curved portion.

### BRIEF DESCRIPTION OF THE DRAWINGS

FIG. 1A is a perspective view of an embodiment of a urinal holder.

FIG. 1B is a perspective view of another embodiment of a urinal holder.

FIG. 2A is a cross sectional side view of the urinal holder of FIG. 1A.

FIG. 2B is a cross sectional side view of the urinal holder of FIG. 1B.

FIG. 3 is a perspective view of an exemplary urinal.

FIG. 4 is a cross sectional side view of the urinal holder of FIG. 1A holding an exemplary urinal.

FIG. 5 is a perspective view of another embodiment of a urinal holder.

FIG. 6 is a perspective view of another embodiment of a urinal holder.

FIG. 7 is a perspective view of another embodiment of a urinal holder.

FIG. 8 is a top view of another embodiment of a urinal holder.

FIG. 9 is a cross sectional side view of another embodiment of a urinal holder.

FIG. 10 is a cross sectional side view of the embodiment of FIG. 9 without an extension.

FIG. 11A is a cross sectional side view of the embodiment of FIG. 1A with a curved extension.

FIG. 11B is a cross sectional side view of the embodiment of FIG. 1B with a curved extension.

FIG. 12 is a perspective view of another embodiment of a urinal holder.

FIG. 13 is a perspective view of another embodiment of a urinal holder.

FIG. 14 is a perspective view of the urinal holder of FIG. 1A hanging on a bed frame rail.

### DETAILED DESCRIPTION

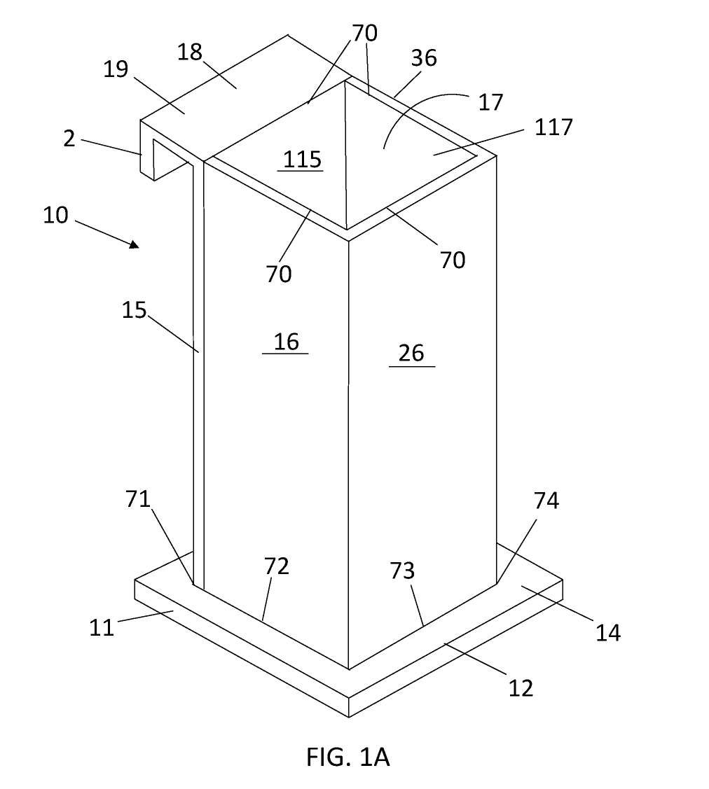

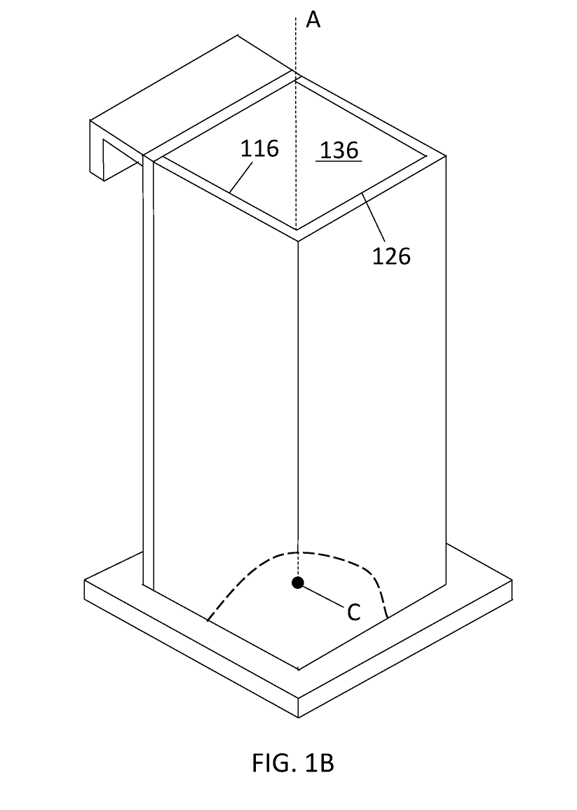

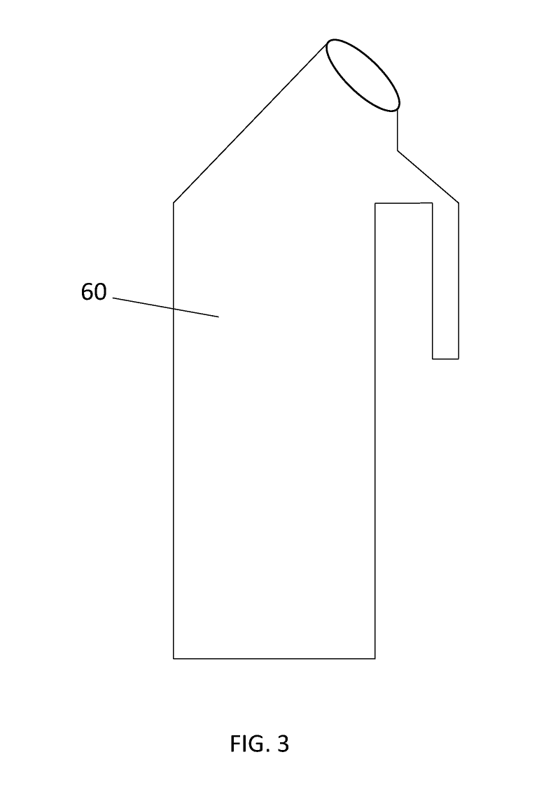

Referring now to FIG. 1A-4, an embodiment of a urinal holder 10 includes a base 11 and at least one side wall 15. A urinal 60 may be stored in a cavity 17 at least partially defined by the at least one side wall 15 and the base 11. The cavity 17 is at least partially bounded by an inner surface 115 of the at least one side wall 15 and a base first surface 14. An open end 117 of the cavity 17 allows for insertion of the urinal 60 into the cavity 17.

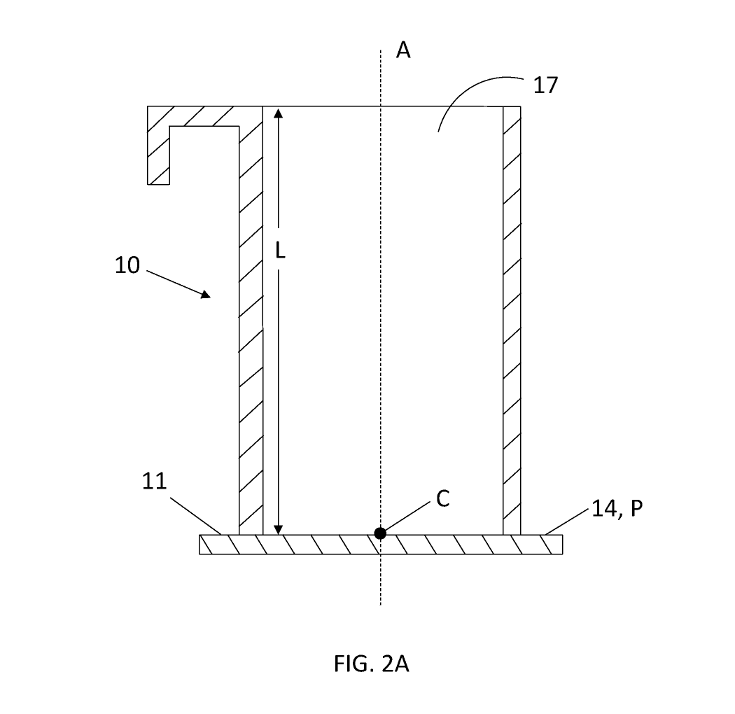

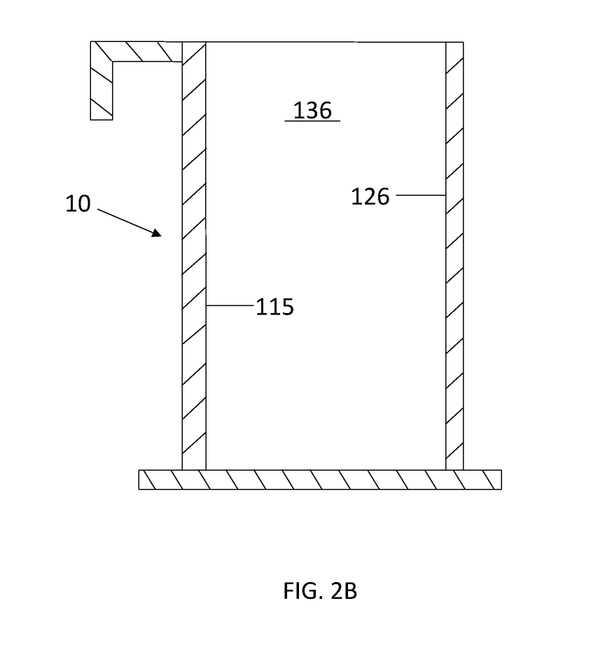

The center point C of the base 11 is one point on a line forming the central longitudinal axis A of the cavity 17. As shown in FIG. 2A, the center point C lies on the base first surface 14. The base first surface 14 is coplanar with a plane P that is orthogonal to the central longitudinal axis A. In this embodiment the base is a rectangle and may be a square, for example, and the center point C is the standard geometric center, or centroid.

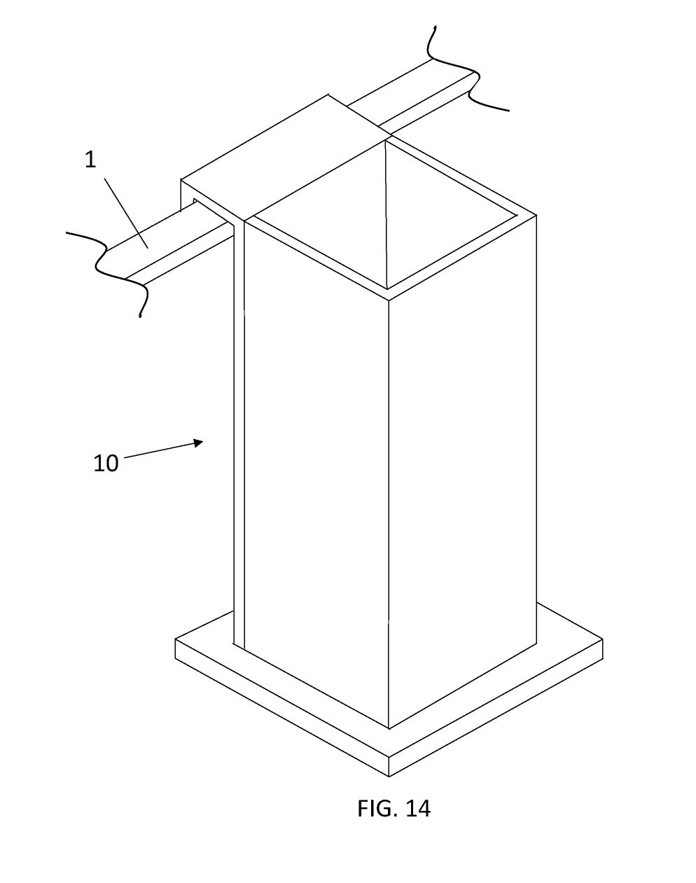

An extension 18 may be coupled to the at least one side wall 15. The extension 18 may be integrally formed with the at least one side wall 15 as shown in FIGS. 1A and 2A or may be formed separately from the at least one side wall 15 and coupled thereto as shown in FIGS. 1B and 2B, for instance using adhesive or a fastener such as a screw or nail. Those skilled in the art will realize that several different fastening methods may be used. The extension 18 may include a first flat portion 19 and second flat portion 2, formed at an angle to each other, for example, so that the urinal holder 10 may be hanged from a separate structure, such as a bed rail 1 as shown in FIG. 14. The extension 18 therefore allows for versatility in storing the urinal 60 when not in use. In some scenarios, it may be easier for a user who is bedridden, such as a medical patient, for example, to place the urinal 60 in the urinal holder 10 while the urinal holder 10 hangs at a location closer to the patient's reach, instead of potentially being placed too far for the patient to safely reach, such as on a bedside table.

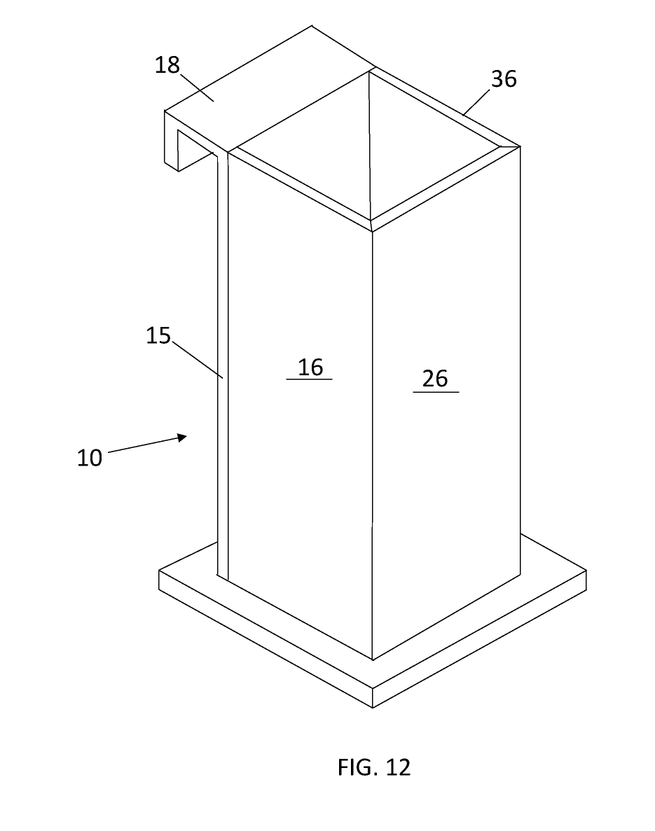

In the embodiments shown in FIG. 1A-4 and FIG. 7-14, the urinal holder 10 may also include a second side wall 16, third side wall 26, and fourth side wall 36. The at least one side wall 15, second side wall 16, third side wall 26, and fourth side wall 36 may be formed integrally as one unitary piece, or may be formed separately and coupled together using adhesive or fasteners such as screws or nails. Also, the second side wall 16, third side wall 26, and fourth side wall 36 may be formed integrally as one piece and coupled to a separately formed at least one side wall 15. One skilled in the art will readily understand that many iterations of structure are possible. Collectively, side wall opening edges 70 of the side walls define the opening 117 for inserting the urinal 60 into the cavity 17.

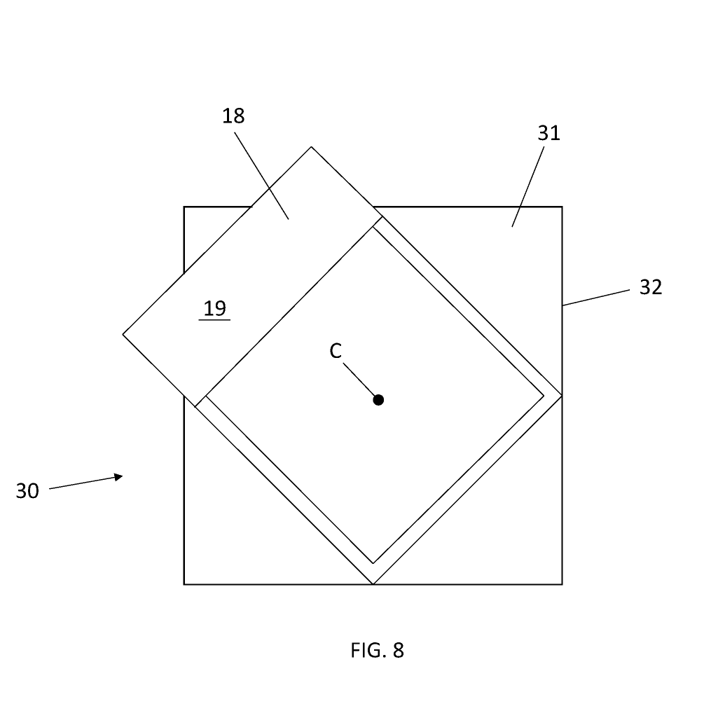

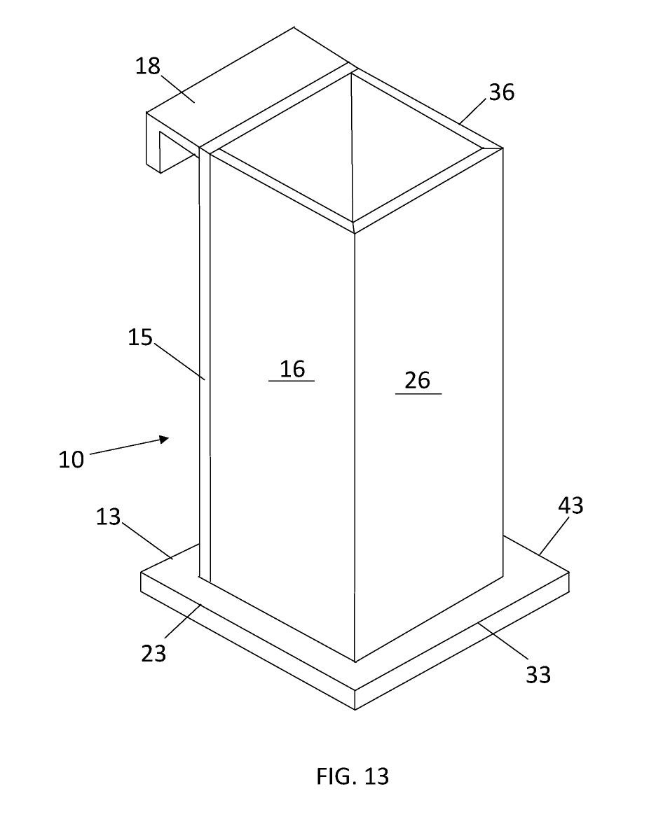

The at least one side wall 15 is coupled to the base 11 at a location spaced apart from the perimeter 12 of the base 11. In some embodiments, each additional side wall 16, 26, and 36 is also coupled to the base 11 at a location spaced apart from the perimeter 12 of the base 11. This arrangement allows for improved stability of the urinal holder 10 when resting on a table for instance, as the user may accidentally impact the urinal holder 10 and would be frustrated if the urinal holder 10 was easily knocked over, especially when holding a partially or completely filled urinal. Particularly in bedside patient care, urinals may be left partially or completely filled for periods of time before support staff can empty them. It is important that the urinal holder 10 have the stability to maintain its position when resting on a surface without having the need to permanently or temporarily fix the urinal holder 10 to a surface using adhesive, hook and loop fasteners such as those sold under the trade name VELCRO, or fasteners such as screws or nails, for example. The at least one side wall 15 may be coupled to the base 11 at a location at least about 0.75 inches from the perimeter 12 of the base 11. This location may be any location along the entire at least one side wall base edge 71. The second side wall 16, third side wall 26, and fourth side wall 36 may be coupled to the base 11 at a location at least about 0.75 inches from the perimeter 12 of the base 11. This location may be any location along the entire second side wall base edge 72, third side wall base edge 73, and fourth side wall base edge 74. As shown in FIG. 8, in some embodiments a portion of the side wall base edges may be coupled to the base at a location spaced apart from the perimeter 32 of the base 31. Said portion of the side wall base edges may be coupled at least about 0.75 inches from the perimeter 32 of the base 31, whereas other portions of the side wall base edges may be coupled at locations more or less than 0.75 inches from the perimeter 32 of the base 31, up to and including being coupled at the perimeter 32. As shown in FIG. 13, the at least one side wall 15, second side wall 16, third side wall 26, and fourth side wall 36 may be coupled at a location spaced apart from base first edge 13, base second edge 23, base third edge 33, and base fourth edge 43, respectively.

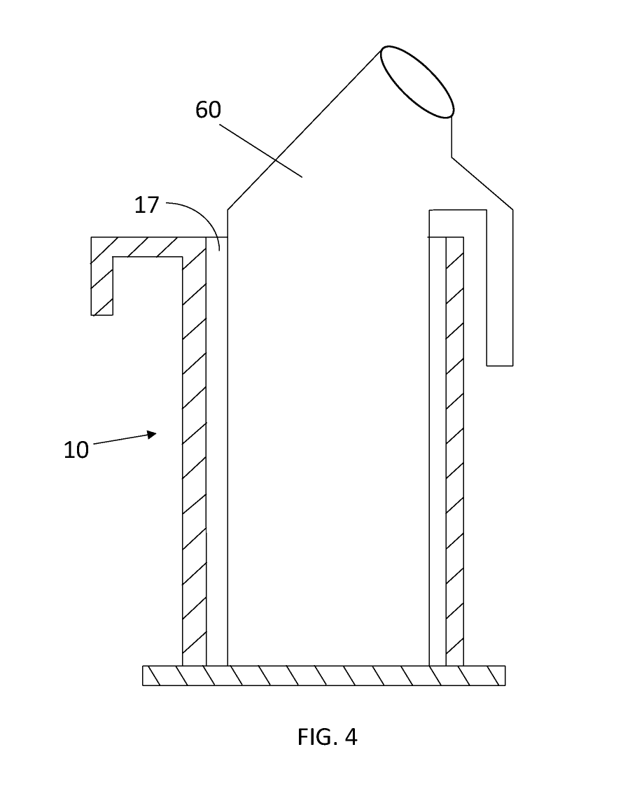

A length of the at least one side wall 15, and any other side walls, may be changed depending on the size of the urinal that may be used. For instance, in one embodiment, the length L of the at least one side wall 15 may be at least about 7 inches. In this embodiment, the length L provides an appropriate height for sufficiently blocking the visibility of urine inside the urinal 60 when the urinal 60 is inside the cavity 17 of the urinal holder 10. For example, FIG. 4 shows a urinal 60 positioned inside the cavity 17 of the urinal holder 10. In some embodiments, a length L of less than 7 inches may be used depending on the size of the urinal and other factors.

In each embodiment, the components of the urinal holder may be made from a variety of materials and processes depending on factors such as aesthetics, costs, user choice, or more. Such materials can include metal, plastic, and acrylic and may be painted to give color or include aesthetic designs such as sports team logos and other personalizations. Each component may be formed individually or be integrally formed with another component. Such processes can include cutting, stamping, and casting. Other processes such as extrusion and molding may also be used. For example, in some embodiments, the components of the urinal holder 10 can be cut from acrylic sheets and coupled together using an adhesive. Such adhesive could include solvent based adhesives, pressure sensitive adhesives, and multi-component adhesives. Those skilled in the art will readily understand that the use of many different types of adhesives is possible depending on the characteristics of the structural material. Alternatively, components could be fastened together using fasteners such as screws, nails, and rivets, for example.

In order to prevent odors and otherwise provide the user with the highest level of cleanliness, an antibacterial coating could be used. In medical patient care, in particular, patients may accidentally spill urine or otherwise not fully contain urine in the urinal 60. In this case, an antibacterial coating could be used at any desired location inside or outside the cavity 17, and preferably inside the cavity 17. For example, an antibacterial coating could coat the at least one side wall inner surface 115 and second side wall inner surface 116, third side wall inner surface 126, and fourth side wall inner surface 136. Exemplary antibacterial coatings can include sodium bicarbonate and hydrogen peroxide. It should be understood that other antibacterial coatings may be used and the examples listed herein do not represent an exhaustive list of possible coatings.

A sealant may be used to prevent leaks or diffusion through the materials of construction, if desired. For example, the sealant may be used at intersections of components, such as the interface between the at least one side wall 15 and the base 11. Also, the sealant may be used to coat any surface in order to prevent diffusion of urine into the surfaces of the components. Certain materials such as plastic or metal may include surface abrasions or cracks that could allow urine to diffuse into the material. Exemplary sealants can include silicone, epoxy, and acrylic resin. Those skilled in the art will readily understand that the use of many different types of sealants is possible depending on the desired performance.

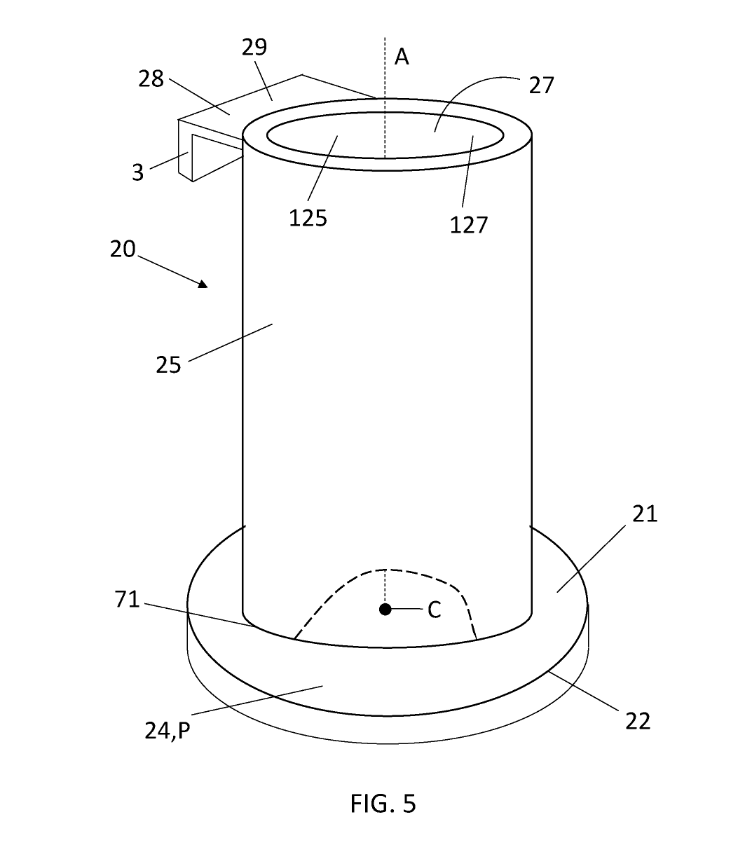

Referring now to FIG. 5, an embodiment of a urinal holder 20 is shown. In this embodiment, the urinal holder 20 includes a base 21 and at least one side wall 25. A urinal 60 may be stored in a cavity 27 at least partially defined by the at least one side wall 25 and the base 21. The cavity 27 is at least partially bounded by an inner surface 125 of the at least one side wall 25 and a base first surface 24. An open end 127 of the cavity 27 allows for insertion of the urinal 60 into the cavity 27. In this embodiment, base 21 is circular in shape and the at least one side wall 25 is the only side wall, formed as one continuous side wall forming a circular cylinder.

The center point C of the base 21 is one point on a line forming the central longitudinal axis A of the cavity 27. As shown in FIG. 5, the center point C lies on the base first surface 24. The base first surface 24 is coplanar with a plane P that is orthogonal to the central longitudinal axis A. In this embodiment the base first surface 24 is a circle and the center point C is the center of the circle.

The at least one side wall 25 is coupled to the base 21 at a location spaced apart from the perimeter 22 of the base 21. In the embodiment shown in FIG. 5, the at least one side wall 25 is coupled to the base 21 at a location at least about 0.75 inches from the perimeter 22 of the base 21. This location may be any location along the entire at least one side wall base edge 71 as the circular cylinder and the circular base may be concentric.

An extension 28 may be coupled to the at least one side wall 25. The extension 28 may be integrally formed with the at least one side wall 25 or may be formed separately from the at least one side wall 25 and coupled thereto, for instance using adhesive or a fastener such as a screw or nail. Those skilled in the art will realize that several different fastening methods may be used. The extension 28 may include a first flat portion 29 and second flat portion 3, formed at an angle to each other, for example, so that the urinal holder 20 may be hanged from a separate structure, such as bed rail 1.

Referring now to FIG. 8, as previously mentioned, a portion of the side wall base edges 71, 72, 73, and 74 of urinal holder 30 may be coupled to the base 31 at a location at least about 0.75 inches from the perimeter 32 of the base 31, whereas other portions of the side wall base edges may be coupled at locations more or less than 0.75 inches from the perimeter 32 of the base 31, up to and including at the perimeter 32.

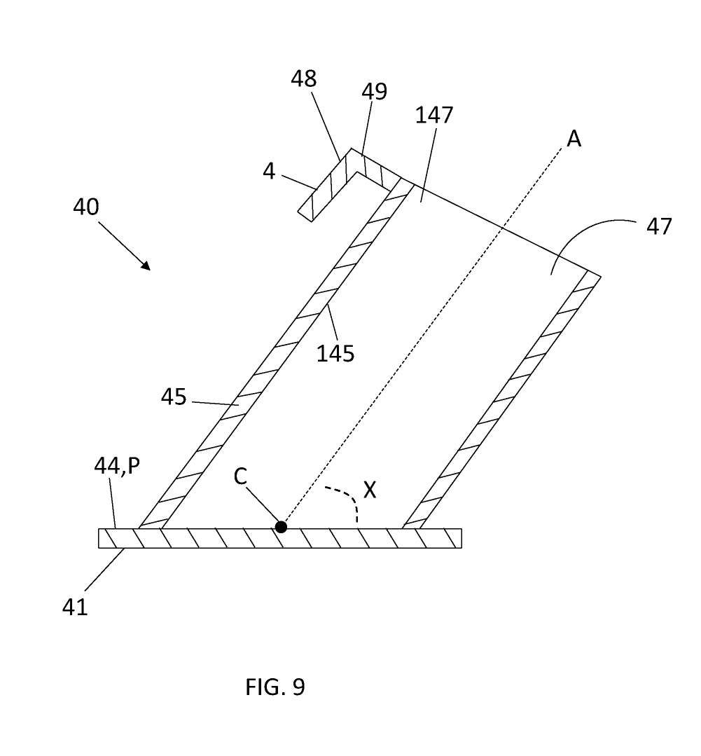

Referring now to FIG. 9, an embodiment of a urinal holder 40 is shown. In this embodiment, the urinal holder 40 includes a base 41 and at least one side wall 45. A urinal 60 may be stored in a cavity 47 at least partially defined by the at least one side wall 45 and the base 41. The cavity 47 is at least partially bounded by an inner surface 145 of the at least one side wall 45 and a base first surface 44. An open end 147 of the cavity 47 allows for insertion of the urinal 60 into the cavity 47.

The center point C of the base 41 is one point on a line forming the central longitudinal axis A of the cavity 47. As shown in FIG. 9, the center point C lies on the base first surface 44. The base first surface 44 is coplanar with a plane P that forms an angle X of less than 90 degrees with the central longitudinal axis A. In this embodiment the base is a rectangle and may be a square, for example, and the center point C is the standard geometric center, or centroid.

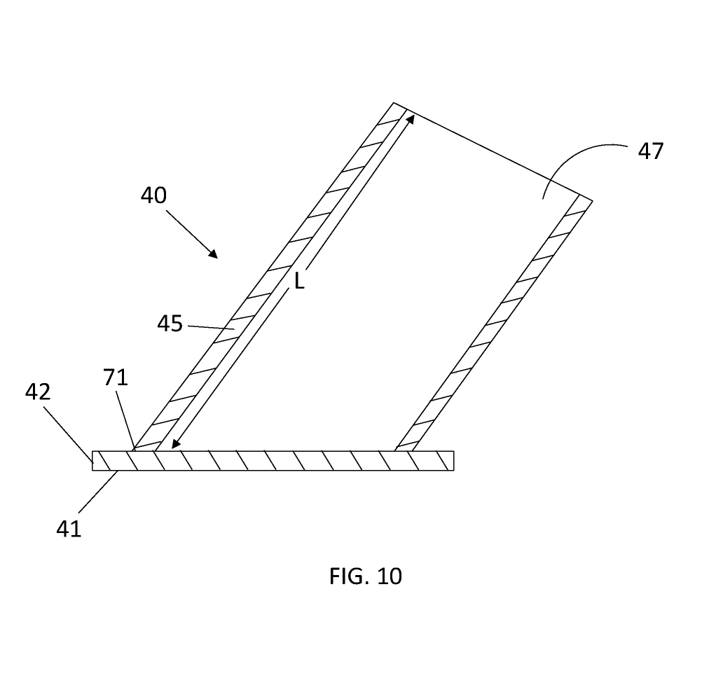

An extension 48 may be coupled to the at least one side wall 45. The extension 48 may be integrally formed with the at least one side wall 45 or may be formed separately from the at least one side wall 45 and coupled thereto, for instance using adhesive or a fastener such as a screw or nail. Those skilled in the art will realize that several different fastening methods may be used. The extension 48 may include a first flat portion 49 and second flat portion 4, formed at an angle to each other, for example, so that the urinal holder 40 may be hanged from a separate structure, such as a bed rail 1. As shown in FIG. 10, the angled configuration of FIG. 9 may be used without the extension 48, as the angled nature of the urinal holder 40 may be well suited for placing on a surface, such as a bedside tabletop, for example. The angled configuration makes for easy insertion of the urinal 60 into the cavity 47 when lying on a bed, requiring less effort by the patient to properly orient the urinal 60 for insertion into the cavity 47.

The at least one side wall 45 is coupled to the base 41 at a location spaced apart from the perimeter 42 of the base 41. In the embodiment shown in FIG. 9-10, the at least one side wall 45 is coupled to the base 41 at a location at least about 0.75 inches from the perimeter 42 of the base 41. This location may be any location along the entire at least one side wall base edge 71. The length L of the at least one side wall 45 may be at least about 7 inches.

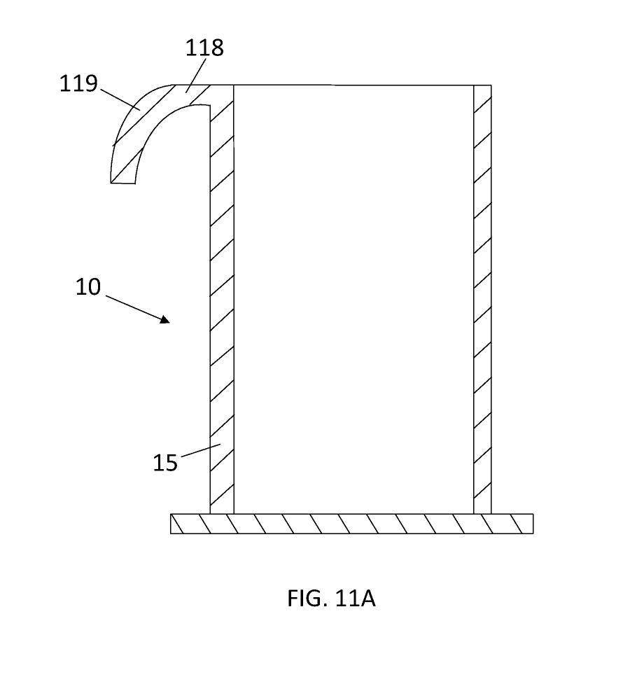

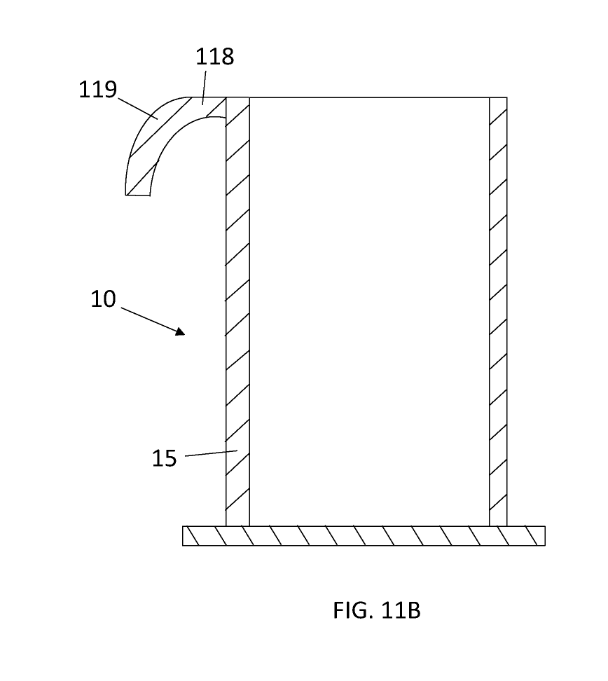

Referring now to FIG. 11A-11B, alternative embodiments of the urinal holder 10 are shown, wherein the extension 118 comprises a curved portion 119. The curved portion 119 can allow for hanging the urinal holder 10 from a bed rail with a circular cross section, for example. FIG. 11A shows an extension 118 formed integrally with the at least one side wall 15, whereas FIG. 11B shows a separately formed extension 118 coupled to the at least one side wall 15, for instance using an adhesive or a fastener such as a screw or nail.

Referring now to FIG. 14, a urinal holder 10 may hang from a bed rail 1 as previously mentioned. In some use cases, the urinal holder 10 may hang from other suitable structures. In some examples, the patient bed frame may include additional structure that may interact with the base 11 to provide greater support for the urinal holder 10. In other words, without a base 11, the urinal holder 10 may swing if the bed frame is not perfectly suited for use with a particular embodiment of the urinal holder 10. For example, the extension 18 and base 11 may be sized so that they can both interact with a bed frame to maintain a stationary position when hanging from the bed rail 1.

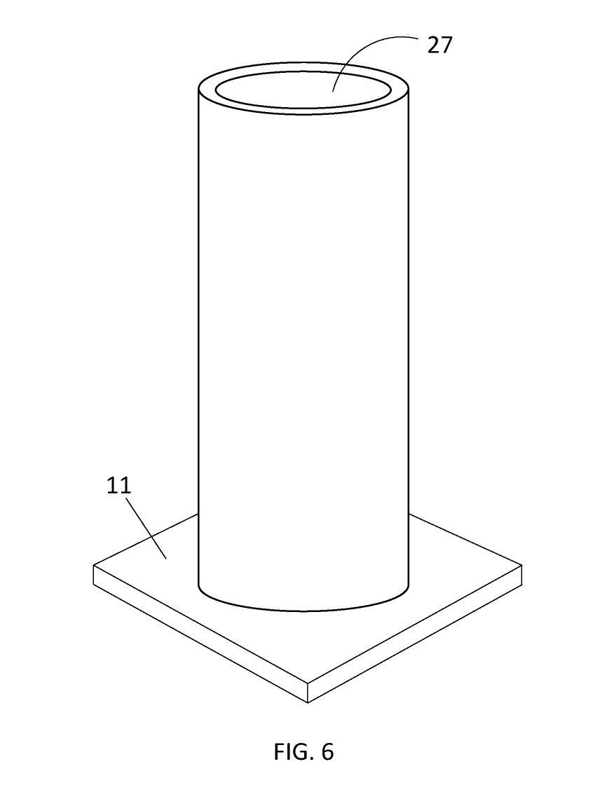

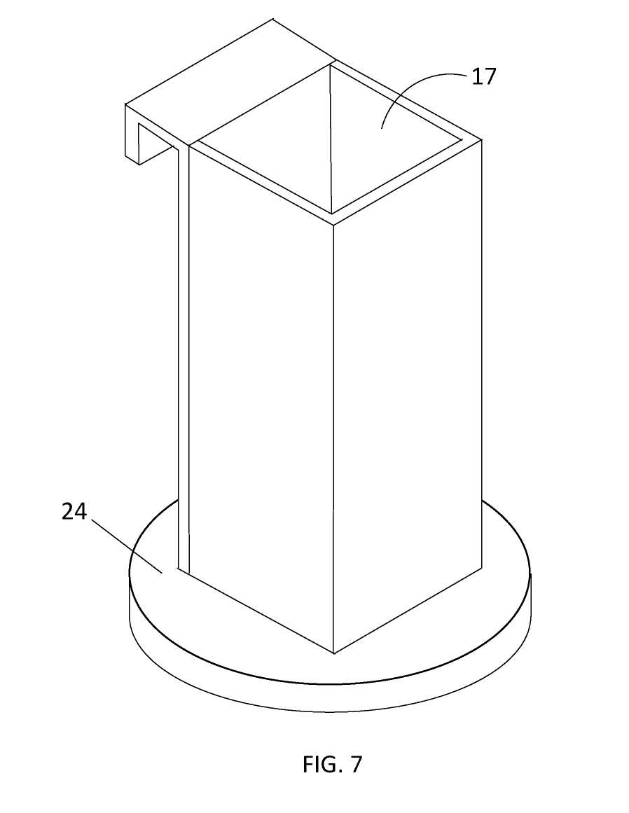

It should be understood that several embodiments of a urinal holder have been disclosed, however this disclosure is not exhaustive of every possible embodiment. Any of the disclosed features can be mixed and matched among various embodiments without departing from the scope of the appended claims. For example, in FIG. 7, an embodiment of the urinal holder similar to FIG. 1A may include a rectangular shaped cylindrical cavity 17 but use a circular shaped base 24. Similarly, FIG. 6 shows an embodiment of the urinal holder having a circular shaped cylindrical cavity 27 with a rectangular base 11. Additionally, other shapes may be used for the cavities and bases that are not shown herein, but still fall under the scope of the claims. Also, for example, components can be one continuous piece or several pieces coupled together. Sealants and antibacterial coatings may or may not be used, as well as adhesive or fasteners as needed for holding multiple components together.

1. A urinal holder comprising
a base;
at least one side wall;
a cavity for holding a urinal at least partially defined by the base and the at least one side wall;
wherein the at least one side wall is coupled to the base at a location spaced apart from a perimeter of the base.

2. The urinal holder of claim 1 wherein the base has a first surface, and a center of the first surface is a point on a line that forms a central longitudinal axis of the cavity.

3. The urinal holder of claim 2 wherein the first surface is coplanar with a plane that is orthogonal to the central longitudinal axis.

4. The urinal holder of claim 2 wherein the first surface is coplanar with a plane that forms an angle less than 90 degrees with the central longitudinal axis.

5. The urinal holder of claim 1 further comprising an extension coupled to the at least one side wall for hanging the urinal holder.

6. The urinal holder of claim 5 wherein the extension is integrally formed with the at least one side wall.

7. The urinal holder of claim 5 wherein the extension comprises a curved portion.

8. The urinal holder of claim 5, wherein the extension comprises a straight portion.

9. The urinal holder of claim 1 wherein the at least one side wall is coupled to the base at least about 0.75 inches from the perimeter of the base.

10. The urinal holder of claim 1 wherein the at least one side wall has a length of at least about 7 inches.

11. A urinal holder comprising
a base;
a first side wall coupled to a second side wall, the second side wall coupled to a third side wall, the third side wall coupled to a fourth side wall, the fourth side wall coupled to the first side wall;
a cavity for holding a urinal defined by the base and the first, second, third, and fourth side walls;
wherein the first, second, third, and fourth side walls are coupled to the base at locations spaced apart from a perimeter of the base.

12. The urinal holder of claim 11, wherein the first, second, third, and fourth side walls are coupled to the base at least about 0.75 inches from the perimeter of the base.

13. The urinal holder of claim 11 further comprising an extension coupled to one of the first, second, third, and fourth side walls for hanging the urinal holder.

14. The urinal holder of claim 13 wherein the extension is integrally formed with the one of the first, second, third, and fourth side walls.

15. The urinal holder of claim 13 wherein the extension comprises a curved portion.

16. The urinal holder of claim 13 wherein the extension comprises a straight portion.

17. A urinal holder comprising
a base with a first edge, a second edge, a third edge, and a fourth edge;
a first side wall coupled to a second side wall, the second side wall coupled to a third side wall, the third side wall coupled to a fourth side wall, the fourth side wall coupled to the first side wall;
a cavity for holding a urinal defined by the base and the first, second, third, and fourth side walls;
wherein the first, second, third, and fourth side walls are coupled to the base at locations spaced apart from the first edge, second edge, third edge, and fourth edge of the base, respectively.

18. The urinal holder of claim 17 further comprising an extension coupled to one of the first, second, third, and fourth side walls for hanging the urinal holder.

19. The urinal holder of claim 18 wherein the extension is integrally formed with the one of the first, second, third, and fourth side walls.

20. The urinal holder of claim 18 wherein the extension comprises a curved portion.

21. The urinal holder of claim 18 wherein the extension comprises a straight portion.
